(19) United States
(12) Patent Application Publication
(10) Pub. No.: US 2017/0036940 A1
(43) Pub. Date: Feb. 9, 2017

(54) Modular Mold Assembly and Method to Use Same

(71) Applicants: Joel David Sharp, Jonesboro, AR (US); Elliot Austin Dale Sharp, Jonesboro, AR (US)

(72) Inventors: Joel David Sharp, Jonesboro, AR (US); Elliot Austin Dale Sharp, Jonesboro, AR (US)

(21) Appl. No.: 15/230,152

(22) Filed: Aug. 5, 2016

Related U.S. Application Data
(60) Provisional application No. 62/201,339, filed on Aug. 5, 2015.

(51) Int. Cl. C03B 9/347

(52) U.S. Cl. CPC C03B 9/347

(57) ABSTRACT

A modular mold assembly comprising two mold halves wherein each mold half comprises separable and interchangeable components that allow for the production of a plurality of unique glass containers is discloses. A new method of manufacturing customized glass containers which utilizes such modular mold assembly is also disclosed.

### PRIORITY

This application claims the priority to U.S. Provisional Patent Application No. 62/201,339 entitled “A Modular Mold Assembly and Method to Use Same” filed on Aug. 5, 2015, and incorporates such reference in its entirety.

### FIELD

A modular mold assembly comprising two mold halves wherein each mold half comprises separable and interchangeable components that allow for the production of a plurality of unique glass containers is disclosed. A new method of manufacturing customized glass containers which utilizes such modular mold assembly is also disclosed.

### BACKGROUND

Use of glass for containers dates back over 3000 years ago when the Egyptians used glass for cosmetics and perfumes. Today, glass containers are used for numerous products including but not limited to candles, jams and jellies, health and beauty products, dressings and marinades, beverages, sauces and salsa, and wine, spirits and mixers. Common examples of glass containers manufactured everyday include jars and serving vessels such as bottles, decanter and handled jugs. For more than 2000 years, glass containers were manufactured by use of the blowpipe, which made it possible to make glass containers larger and much more uniform in size and shape. In 1903, the first fully automatic glass bottle machine was perfected. The automatic glass bottle machine could do the work of dozens of glass blowers and thus revolutionized the glass industry. The first machine made about nine bottles per minute. By comparison, some of today's machines can make over 700 bottles per minute.

Today, glass container manufacturing starts with the design of the glass container. A well designed glass container helps the product inside look its best. Additionally, a well-designed glass container allows the container to identify its source. Glass manufacturers work closely with their customers to make sure that the design provides the best combination of appearance, strength, weight and ease of handling. Designers concentrate on each area of the container including the finish, closure, neck, shoulder, sidewall, heel and bottom. The shape and thickness of each of these areas is critical to the overall design of the glass container. Once a design, unique to a single final container, is completed a unique mold set is manufactured based on such design. Such mold set will be used in the forming machines to produce the final container. Acquisition of a full, unique mold set is very expensive; the cost starting at fifty thousand United States dollars.

The manufacturing process of glass containers comprises several stages including the batch house, the furnace, the forming machines (where the mold sets are utilized to form the final container), automatic inspection, warehousing and shipping. Each of these areas is crucial to the manufacturing process. Glass production starts with the arrival of raw materials: silica sand, soda ash and limestone. Sand, the basic ingredient of glass containers, makes up about seventy percent of the raw materials. Soda ash, another ingredient, is used to melt the sand evenly at a lower temperature. Additionally, limestone is added to reduce the expansion rate to make the container easier to form and improves chemical durability. Other raw materials may be used in smaller amounts to create the various colors of glass, as desired. A fourth ingredient often used to make glass containers is cullet, which is recycled glass from containers that have been color sorted, then crushed and returned to the plant to be made into new bottles. Adding cullet reduces the amount of raw materials needed and provides energy savings by lowering the melting temperature.

After unloading, all raw materials are brought together in the batch house, where under computer control, they are carefully weighed and then mixed together. Next, the batch is transported to the glass furnace where it is metered in at the same rate as the molten glass is removed from the other end, thus keeping the glass inside the furnace at almost exactly the same depth at all times. It is important to control the depth of the glass to within +or −1/100th of an inch to insure consistent glass making. At a temperature of around 2,850 degrees Fahrenheit, the raw materials melt together to form molten glass.

A typical glass furnace is made up of high temperature ceramic brick. Some of the individual bricks are large blocks weighing over a ton. The furnace can be heated by any combination of electricity, gas or oil depending upon cost and availability. In addition, oxifuel technologies may be used to achieve cleaner burning and more efficient melting. A typical furnace may hold up to 500 tons of glass and can be as much as 50 feet tall. It typically runs virtually 24 hours a day, 365 days a year.

From the furnace, the glass flows into the refiner where trapped gas bubbles are allowed to escape. A process known as fining. After the fining process is complete, the glass now flows into a long chamber called the forehearth to reduce the temperature of the glass to make it thicker. The forehearth is designed to cool the glass evenly to an average container forming temperature of about 2100 degrees Fahrenheit.

After traveling through the forehearth, the glass moves into the feeder, which is the first step in transforming the molten glass into a finished container. Plungers, or needles, push the glass through an orifice at the bottom of the feeder. Each stroke of the plungers pushes glass through the orifice. After the glass goes through the orifice, it is cut by shear blades at the precise instant to form an elongated cylinder of molten glass called a gob. Each gob makes one glass container. The height of the tube, the stroke of the plunger, the size of the orifice, and the frequency of the shear cut, all determine the size of the gob and therefore ultimately, the size and the weight of the resulting glass container. There is an optimum gob shape for each glass container produced.

Once the gob is cut, it travels through a series of chutes to the blank mold of a forming machine, where the gob will be formed into a parison. Each gob first falls into a scoop, which directs the gob onto the correct path to a specific mold. The gob typically slides through a trough into a deflector and then into the first of two molds on the forming machine. The forming machine may be an individual section machine (often referred to as an I.S. Machine). The I.S. Machine ensures efficient production because it allows operators to take one or more section out of production for repairs if and when needed without shutting down production in other sections. Gobs of molten glass enter the I.S. Machine and are formed into final containers through a process of controlled shaping and cooling of the glass. The amount of time need to produce a container varies depending on the container's size and shape but it may be as little as 10 seconds, allowing the formation machine to produces hundreds of containers per minute.

Once the gob slides into the first mold, the blank mold, the finish is molded and the rest of the gob is formed into an elongated shape called a parison, a partially shaped mass of molten glass. A parison is a hollow and partially formed container that will be blown up like a balloon when transferred into the blow mold to form a final container. Parisons are formed on the blank side of the individual section formation machine and differ in shape for each type of container design. A parison has a cooler outer surface of about 1700 degrees Fahrenheit. At this point, the parison is upside down and does not look like a glass container, but it is ready to be transformed into its final shape. From the blank mold, the parison is inverted and transferred to the blow mold, located on the blow side, opposite the blank side, of the formation machine, where the parison is inflated with compressed air into its final shape. Both the blow mold and the blank mold comprise two mold halves made of metal, wherein each mold half comprises a single unitary, non modular component. The mold halves close together within the forming machine to form the parison (blank mold) or the final container (blow mold).

There are two common processes that can be used to form the glass container: the blow and blow method and the press and blow method. The blow and blow process begins as the gob enters the blank mold through a funnel. The funnel acts as a guide to load the gob into the center of the blank mold. A baffle then seats on the funnel and settle blow air is injected through holes in the baffle to force the glass into the bottom of the blank mold until it surrounds a small plunger. Next, the baffle lifts off allowing the funnel to escape; then, the baffle reseats directly on the blank mold. Counter blow air is then blown through small holes in the plunger to form a bubble that forces the glass to conform to the interior shape of the blank mold. The resulting glass shape is called the parison which is transferred to the other side of the forming machine by the invert into the blow mold. A blow head then seats over the finish of the parison and air is injected to inflate and stretch the glass to its final shape. The blow mold opens and the finished container is removed by the take out. The blow and blow process works best for containers that have narrow openings such as bottles.

With the press and blow method using a post style baffle, the gob loads through a funnel that is built into the top of the blank mold. The baffle then caps the top of the mold and a long plunger pushes up from the bottom causing the glass to conform to the inside of the blank mold forming the parison. The parison is then transferred and inflated in the blow mold in the same manner as described above in the blow and blow process. The press and blow process can be used to make containers with either wide or narrow openings. There are several variations of the press & blow method including the narrow necked press and blow process often used to make beer bottles and the “41” process often used to make for baby food jars.

As stated above, a forming machine is made of smaller machines called sections. The motions of each section may be timed to coordinate with all the other sections but each operates independently of the others. Such independent operation of each section allows a forming machine to keep running while one or more sections are shut down for adjustments or repairs. Each section is fitted with enough molds to make from one to four bottles at a time. The number of molds depends primarily on the size of the glass container being made. Smaller containers are typically made three or four at a time on each section, while larger containers are made two or three at a time. Very large containers are made one at a time on single gob sections. A forming machine may have anywhere from four to twelve sections.

After the glass containers have been formed, they are removed by the take out and held over jets of air that cool the glass to make it more rigid. Then the glass containers are swept onto a machine conveyor. As the containers leave the forming machine, the operator selects a representative sample to measure. These measurements are based on statistical process control techniques and indicate when adjustments are needed to keep the process running within control limits. From the machine conveyor, the glass containers move to the wear transfer and they are loaded into an annealing chamber called a lehr. A newly formed glass container cools rapidly on the outside, but slowly on the inside, creating stress in the glass. The process of annealing relieves the stress by reheating the glass (to approximately 1100 degrees Fahrenheit) and then gradually cooling it. This equalizes the inside and outside stress of the container and makes it stronger. The annealing process may take as long as an hour or as little as thirty minutes depending on the size of the container and the size of the lehr. Special protective coatings, to protect the container from scratches and abrasions, are often applied to the containers before they enter the lehr and after they have emerged from the cool end of the lehr. The protective coatings also add lubricity or slipperiness to the outside surface of the container which helps the containers move smoothly through customer's filling lines and helps to maintain container strength.

After annealing, the containers enter the automatic inspection area where they are subjected to final inspection by electronic gauging equipment which check every container for critical characteristics, such as glass wall thickness, diameter and finish openings. Glass containers that do not meet all these strict requirements are reduced to cullet (recycled glass), re-melted, and used again. In addition, a representative sample of the containers are subjected to a number of quality and strength tests which includes testing their ability to withstand the rapid temperature change, internal pressure, and impact forces that they experience during normal usage. Next, the containers go to the labeling department or directly to the packing area. Some containers are bulk packed on large corrugated tier sheets and stretch wrapped for strength and protection. Others are packed in corrugated boxes. The filled boxes are machine palletized and moved to the warehouse for shipping to the customer. Efficiently moving finished containers from the glass manufacturing plant to the customer is the final step in complete customer satisfaction. Manufacturing, packaging, and transportation all come together to deliver a quality glass container to the customer.

Most glass manufacturing plants have two or more furnaces with each feeding into multiple forming lines allowing the production about three million bottles per day.

Each glass container design is manufactured by implementing the detailed glass manufacturing process as set forth above. As stated above, the final design of a glass container is determined by a mold set which forms the blow mold and typically includes two standard mold halves, a container bottom plate and a neck ring, used during the formation process. Acquisition of a full, unique mold set is expensive beginning at around fifty thousand United States dollars and merely allows for the production of glass containers having a single design. A mold set comprising a modular mold assembly, wherein such modular mold assembly comprises two mold half shells comprising separable and interchangeable components that allow for the production of a plurality of glass containers each having a unique, customized design is needed. A new method of manufacturing glass containers which utilizes a modular mold assembly wherein such modular mold assembly allows for the production of glass containers each having a unique, customized design is also needed.

### BRIEF DESCRIPTION OF THE DRAWINGS

The present disclosure will be better understood by reference to the following detailed description when considered in conjunction with the following drawings wherein:

FIG. 1 is a plan view of the modular mold assembly according to a sample embodiment;

FIG. 2A is a exploded view of the main components of a modular mold assembly of FIG. 1;

FIG. 2B is a side perspective view of the modular mold assembly of FIG. 1;

FIG. 3A is an exploded view of the main components of a non modular mold assembly;

FIG. 3B is a side perspective view of a non modular mold assembly of FIG. 3A;

FIG. 4 is a perspective view of the inner walls of a mold half shell of a modular mold assembly comprising separable and interchangeable components according to one example embodiment;

FIG. 5 is a partial enlarged perspective view of the inner walls of an upper mold component of the mold half shell of FIG. 4;

FIG. 6 is a partial enlarged perspective view of the inner walls of a receiver mold component of the mold half shell of FIG. 4;

FIG. 7 is a partial enlarged perspective view of the inner walls of a lower mold component of the mold half shell of FIG. 4;

FIG. 8 is a partial enlarged side sectional view of the upper mold components of modular mold assembly of FIG. 2A according to one example embodiment;

FIG. 9 is a partial enlarged side section view of the upper mold components according to a second example embodiment;

FIG. 10 is a partial enlarged side section view of the receiver mold components of modular mold assembly of FIG. 2A according to one example embodiment;

FIG. 11 is a partial enlarged side section view of the lower mold components of modular mold assembly of FIG. 2A according to one example embodiment;

FIG. 12 is a side sectional view of the modular mold assembly as seen at line A-A in FIG. 1;

FIG. 13 depicts customized bottles produced by the modular mold assembly according to one example embodiment;

FIG. 14 depicts a blank mold used to manufacture a parison;

FIG. 15 depicts customized bottles produced by the modular mold assembly according to a second example embodiment;

FIG. 16 depicts an additional view of the bottles shown in FIG. 15;

FIG. 17 is a perspective view of the inner walls of a mold half shell of a modular mold assembly comprising separable and interchangeable components according to a second example embodiment;

FIG. 18 is a perspective view of the outer walls of the mold half shell of the modular mold assembly of FIG. 17;

FIG. 19 is an exploded view of the inner walls of the main components of the mold half shell of a modular mold assembly of FIG. 17;

FIG. 20 is a exploded rear view of the main components of the mold half shell of a modular mold assembly of FIG. 17;

FIG. 21 depicts customized glass containers produced by the modular mold assembly according to a third example embodiment;

FIG. 22 depicts an additional view of the glass containers shown in FIG. 22;

FIG. 23 is a perspective view of the inner walls of a mold half shell of a modular mold assembly comprising separable and interchangeable components according to a further example embodiment;

FIG. 24 is an exploded perspective view of the separable and interchangeable components of a mold half shell of a modular mold assembly of FIG. 23.

FIG. 25 is an exploded perspective view of the separable and interchangeable components of FIG. 23.

FIG. 26 is a perspective view of the assembled components of FIG. 23 positioned in front on the module component holder of FIG. 23.

FIG. 27 is a rear perspective view of FIG. 23.

FIG. 28 is a rear perspective view of FIG. 25.

### DETAILED DESCRIPTION

As set forth above and incorporated herein, the manufacturing process of glass containers involves a detailed process. Glass container manufacturing starts with a design of the glass container to be formed during the manufacturing process. Glass manufacturers work closely with their customers to make sure that the design provides the best combination of appearance, strength, weight and ease of handling. Designers concentrate on each area of the container including the finish, closure, neck, shoulder, sidewall, heel and bottom. Once the design of the glass container is determined, a mold set for a blank mold and a blow mold is manufactured based on the custom design. Once the mold set for the blank mold and blow mold have been tested and approved for the manufacture of the desired glass container, a plurality of mold sets are produced and implemented into the individual sections of a forming machine. Each section of a forming machine comprises one or more mold sets determined by the size of the container to be formed. A typical mold set for the blow mold comprises: two standard mold halves, a mold bottom plate and a neck ring. Both the blow mold and the blank mold comprise two mold half shells made of metal, wherein the mold halves close together within the forming machine to form the parison (by the blank mold) or the final container (by the blow mold).

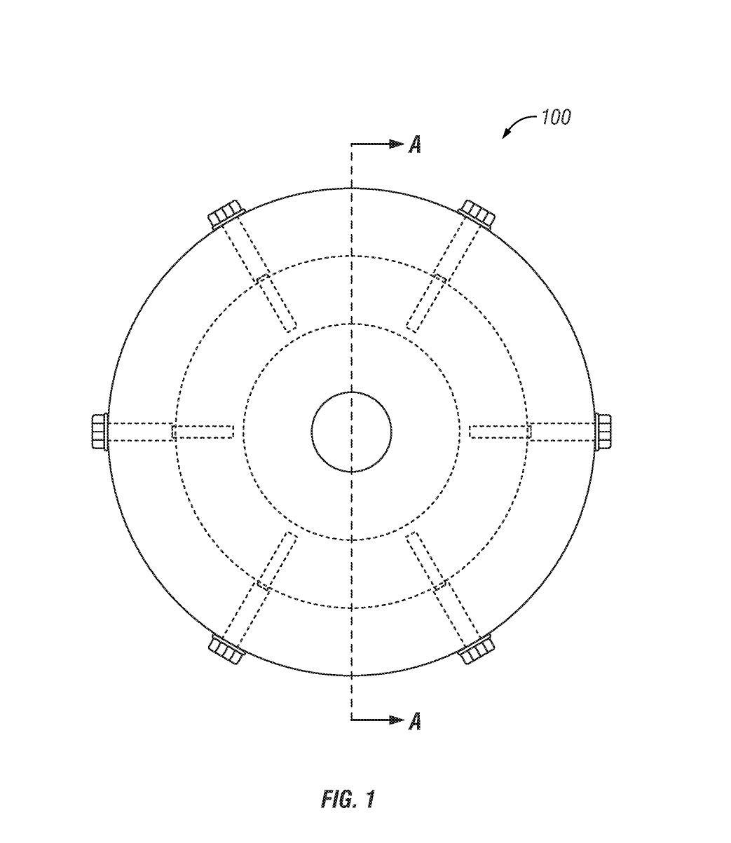

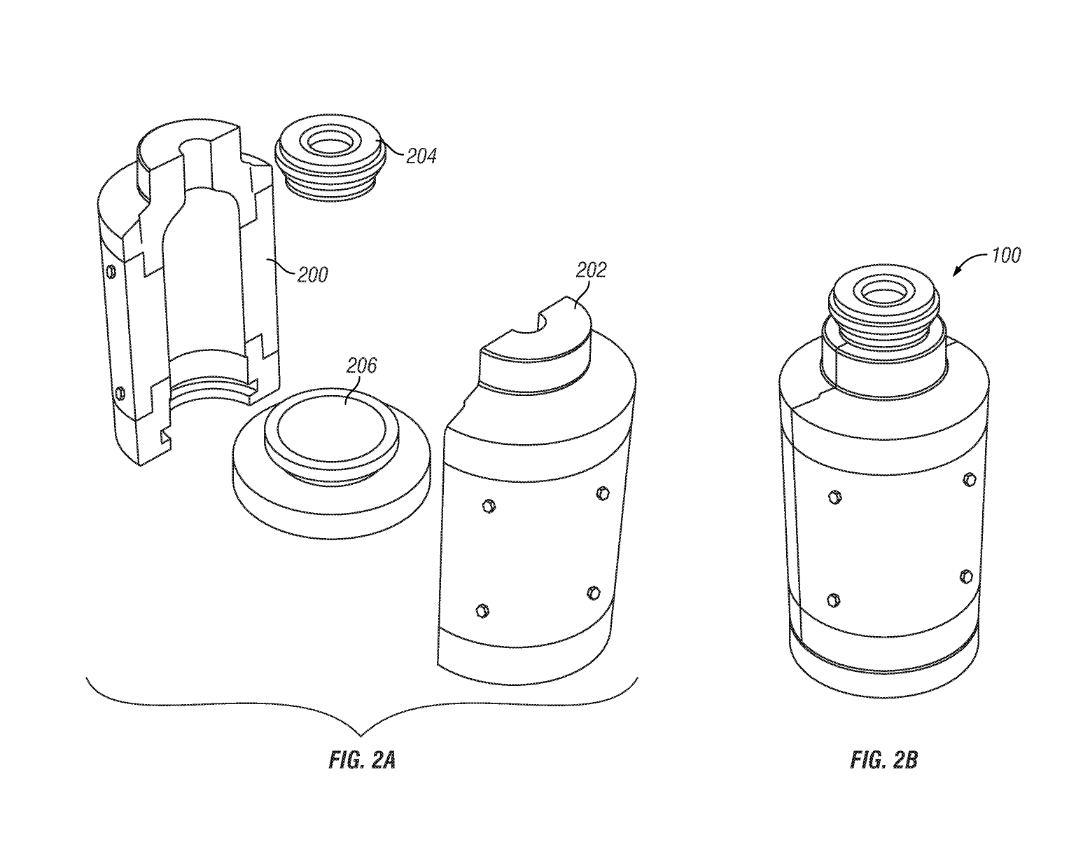

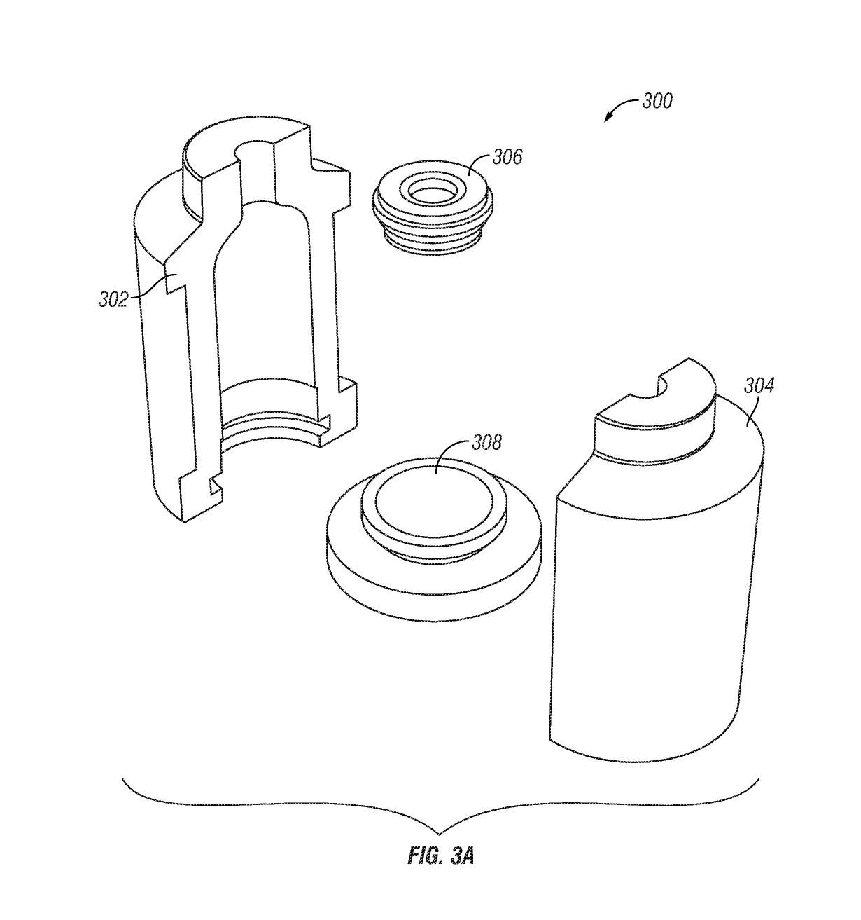

Referring to FIGS. 1 and 2, a modular mold assembly 100 comprising a plurality of separable and interchangeable components used to produce a plurality of glass containers each with a unique design is disclosed. In one embodiment, a modular mold assembly 100 may be used in the glass container manufacturing process to form the final container such as a bottle or jar. A modular mold assembly provides the same function in the glass container manufacturing process as a blow mold.

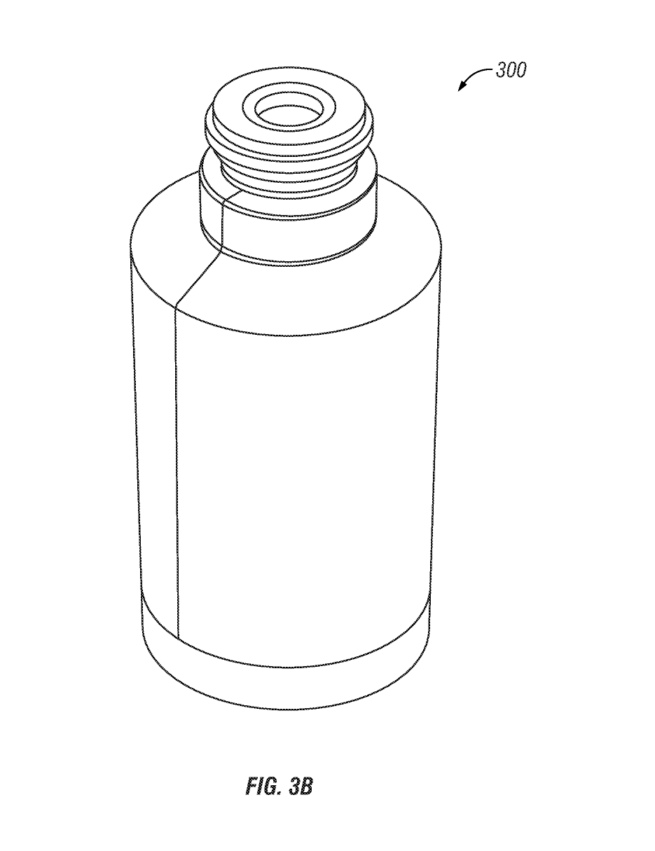

Referring now to FIG. 2A, in one embodiment, a modular mold assembly 100 used to form a glass container comprises two modular mold half shells: a first modular mold half shell 200, a second modular mold half shell 202, a neck ring 204 and a bottom plate 206. Each modular mold half shell 200 and 202 comprises a plurality of separable and interchangeable components that allow for the production of a plurality of glass containers each having a unique, customized design. Referring to FIGS. 3A and 3B, a non modular mold assembly 300 is shown wherein the mold half shells 302 and 304 each comprise one unitary, non-modular component which limits such non modular mold assembly to producing a plurality of glass containers each having the same design. Non modular mold assembly 300 includes neck ring 306 and bottom plate 308.

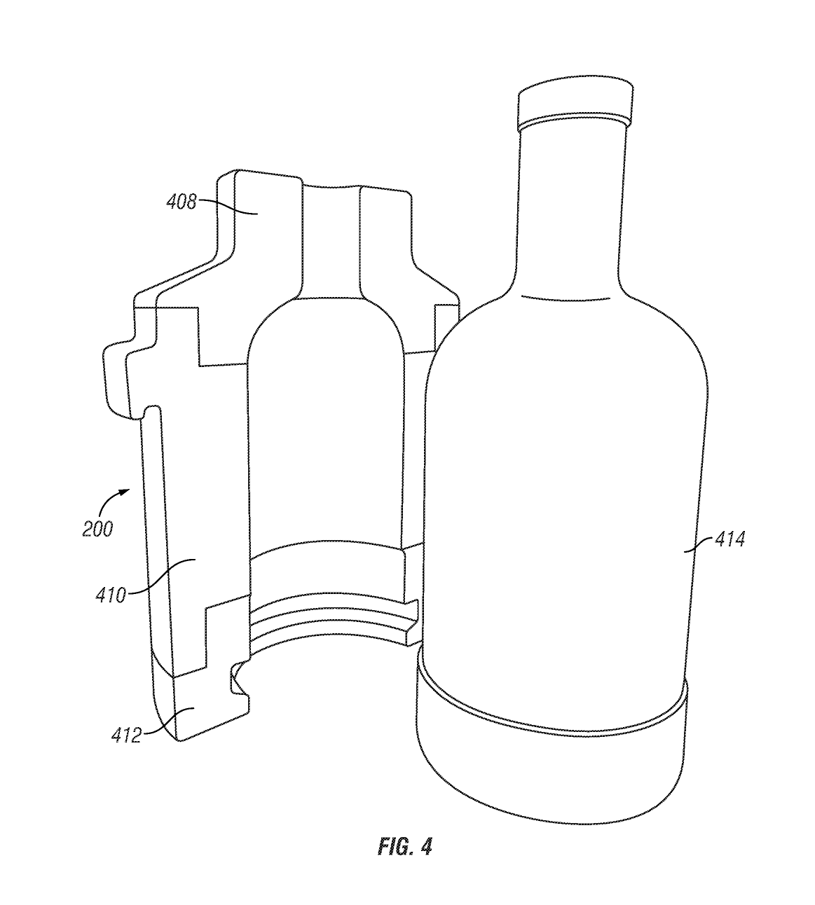

Referring now to FIG. 4, in one embodiment, modular half shell 200 comprises an upper mold component 408, a receiver mold component 410 and a lower mold component 412, wherein the three components are releasably secured together. In one embodiment, the three components are releasably secured together by a plurality of screws. The plurality of components may be secured together by other means as desired by one of skill in the art. Modular half shell 200 corresponds with modular half shell 202 (not shown in FIG. 4) to form a blow mold. During the forming process, the half shells 200 and 202 close together to shape and form a glass container 414.

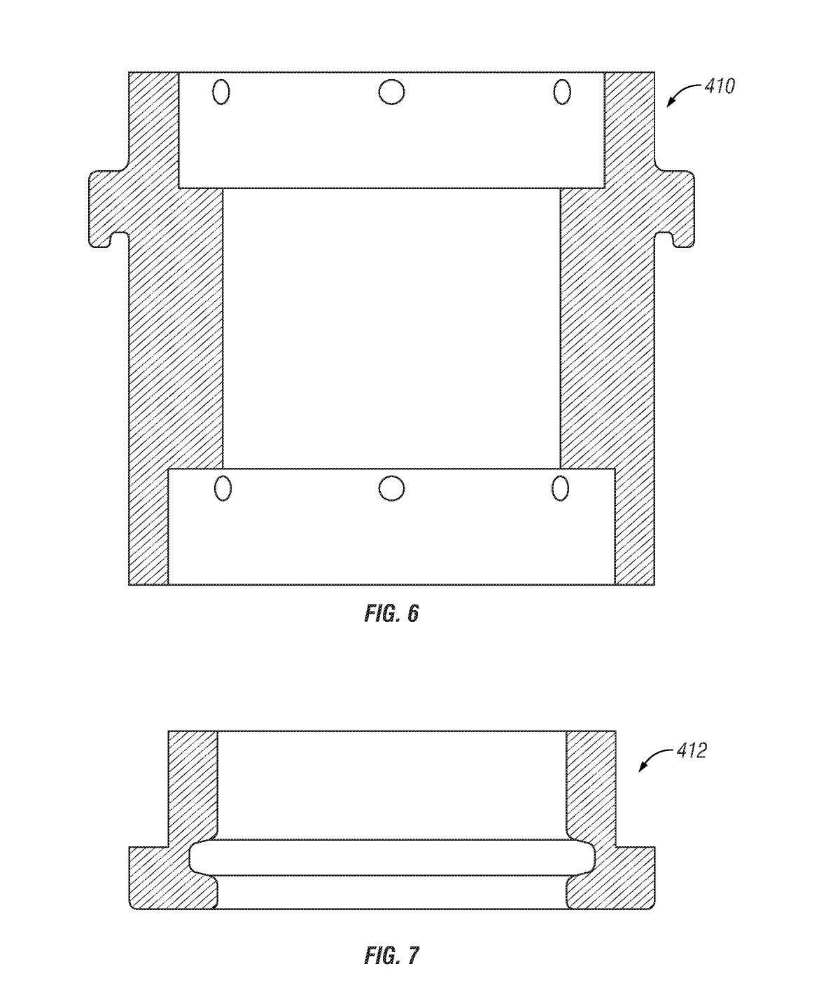

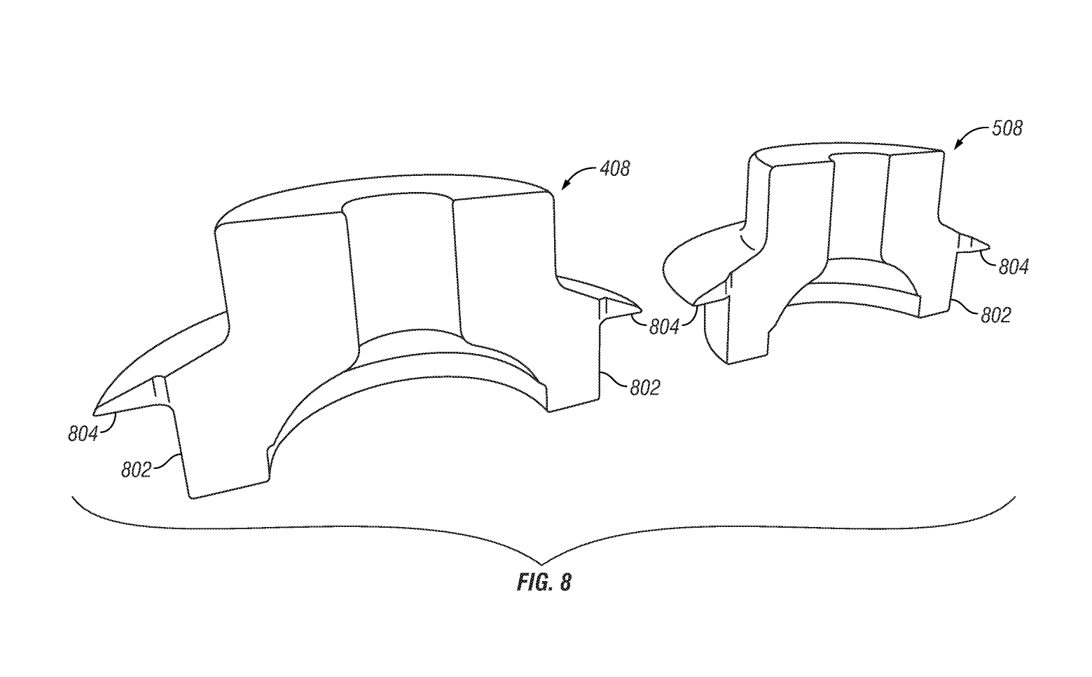

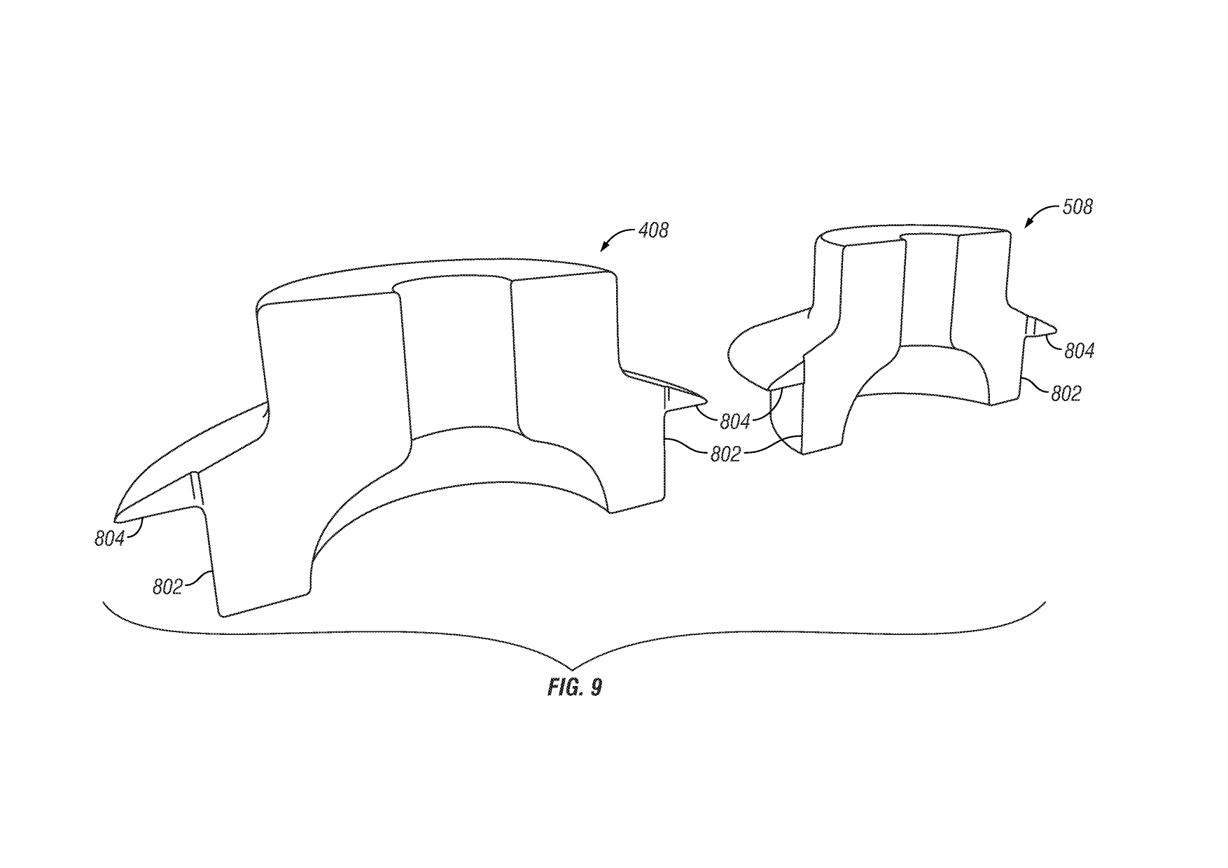

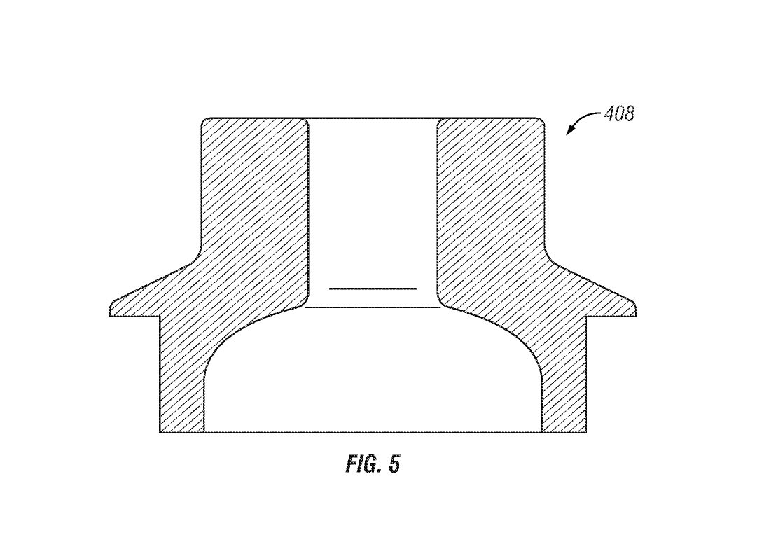

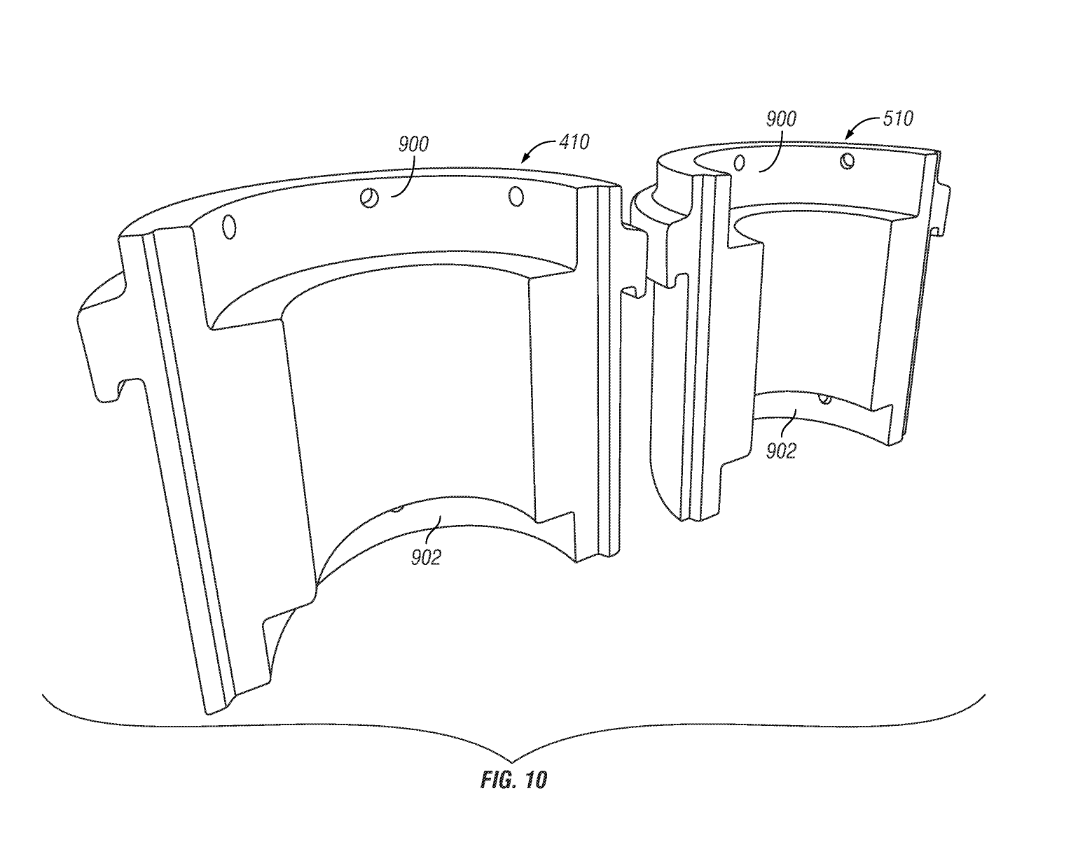

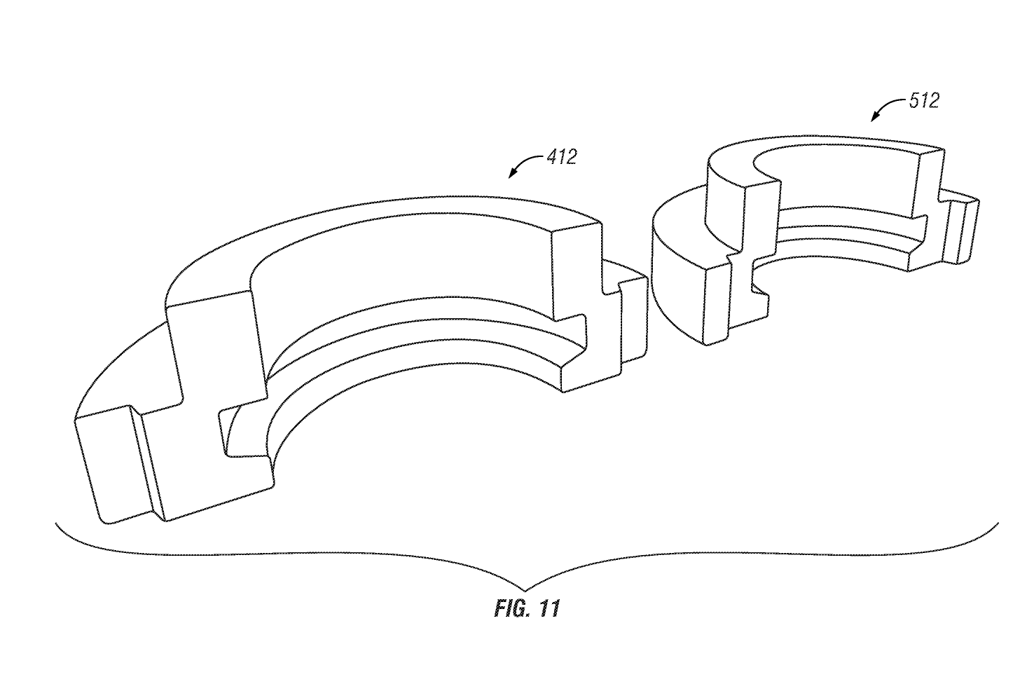

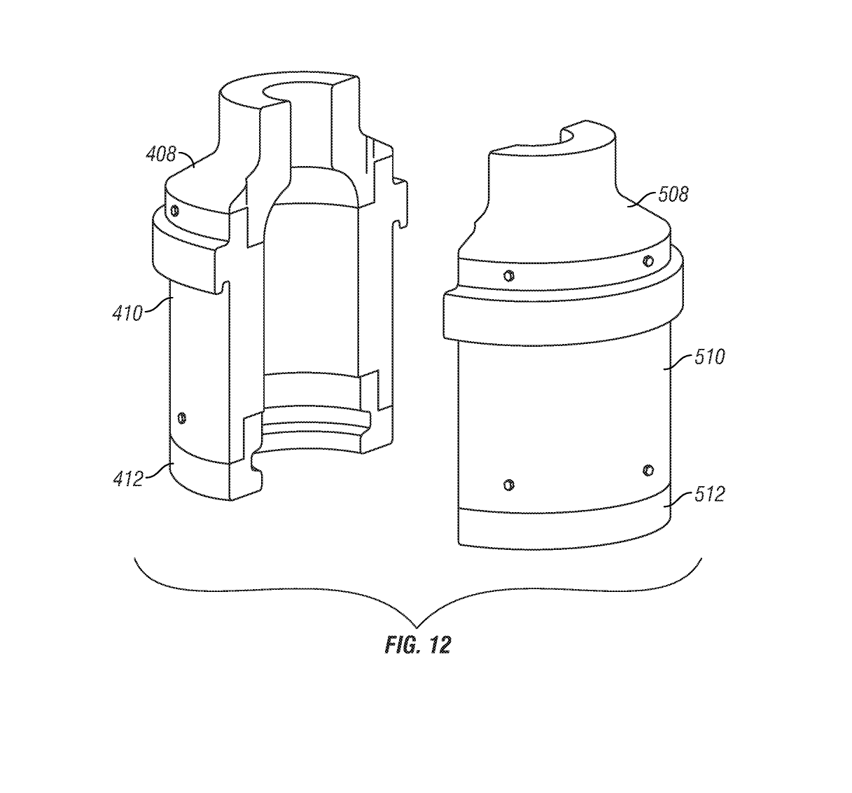

Referring now to FIGS. 5, 8 and 9, in one embodiment, the upper mold components 408 and 508 of both the first and second modular mold half shells 200 and 202 have upper inner walls that define an upper cavity whose shape and design conform to the shape and design of the upper portion of the container to be formed. The upper portion of the container to be formed comprises the shoulder and neck of the container to be formed. Referring now to FIGS. 6 and 10, the receiver mold components 410 and 510 of both the first and second modular mold half shells have receiver inner walls that define a middle cavity whose shape and design conform to the shape and design of the middle portion of the container to be formed. The middle portion of the container to be formed comprises the sidewall. Referring to FIGS. 7 and 11, the lower mold components 412 and 512 of both the first and second modular mold half shells have lower inner walls that define a lower cavity whose shape and design conform to the shape and design of the lower portion of the container to be formed. The lower portion of the container to be formed comprises the heel of the bottle.

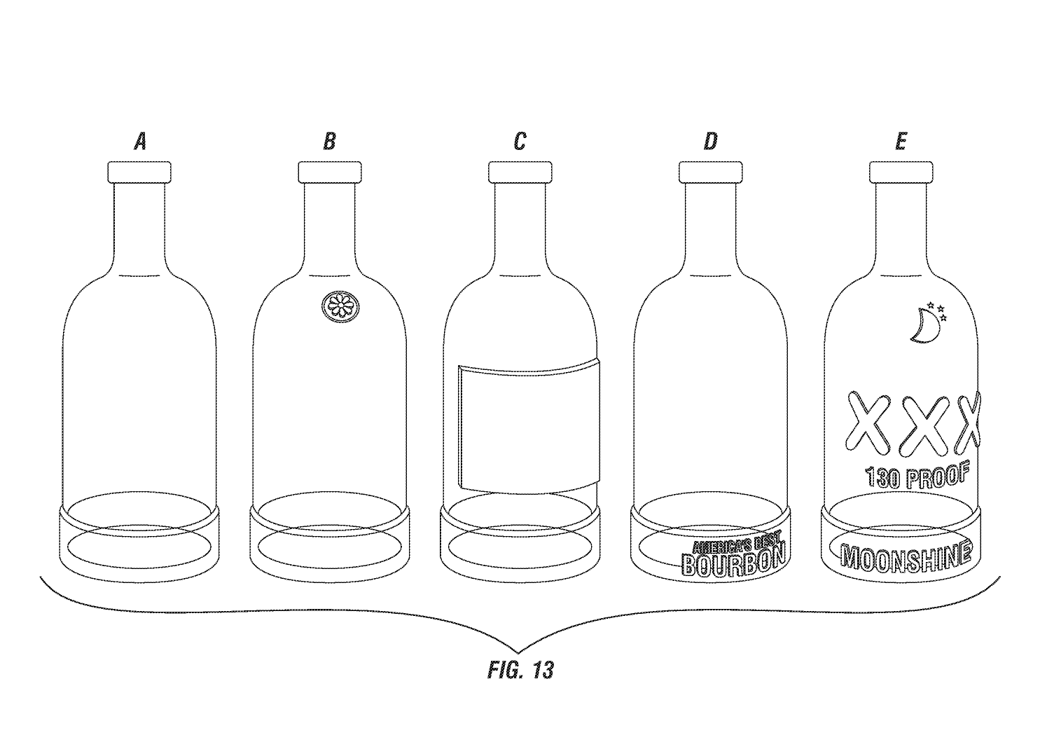

Referring now to FIGS. 8-12, in one embodiment, an upper mold component 408 of the first modular half shell is releasably secured to a receiver mold component 410 of the first modular half shell. Upper mold component 508 of the second modular half shell is releasably secured to a receiver mold component 510 of the second modular half shell. In one embodiment, the upper mold components 408 and 508 of the first and/or second modular half shells, wherein each upper mold component comprises upper inner walls that define an upper cavity having a first particular shape and design, may be interchanged with another upper mold component having upper inner walls that define an upper cavity having a second particular shape and design as long as the structure of the upper mold components of the first and second modular half shells allows the upper mold components of the first and second modular half shells to be releasably secured to the corresponding receiver mold components of the first and second modular half shell. The shape and design of the upper inner walls that define an upper cavity may vary as desired by one of skill in the art to create a plurality of unique, customized containers, as long as the structure of the upper mold component allows the upper mold component to be releasably secured to its corresponding receiver mold component.

Referring to FIGS. 8, 9, and 11, in one embodiment, upper and lower mold components comprise an interlocking section that travels along the outside circumference of the components. Interlocking section of both upper and lower mold components comprises a vertical curved outer wall 802 and a horizontal ledge 804 perpendicular to the vertical outer wall.

In one embodiment, each receiver mold component comprises an upper receiving section 900 and a lower receiving section 902. Upper receiving section receives and interlocks with interlocking section of upper mold component. Lower receiving section of receiver mold component receives and interlocks with interlocking section of lower mold components Each receiving section of receiver mold component comprises a vertical curved inner wall and a horizontal ledge perpendicular to the vertical inner wall. In one embodiment, vertical curved inner wall of each receiving section comprises three apertures configured to align with three corresponding apertures on upper and lower mold components. In one embodiment, the apertures may be threaded to receive screws. In one example embodiment, screws may be used to secure receiver mold component to the corresponding upper and lower mold component to form a first and second modular half shell. In another embodiment, cap screws designed to be seated in countersunk apertures are used to secure receiver mold component to the corresponding upper and lower mold components to form a first and second modular half shell.

In one embodiment, a receiver (or middle) mold component of a first modular half shell may be releasably secured to both an upper mold component of a first modular half shell and a lower mold component of a first modular half shell. A receiver (or middle) mold component of a second modular half shell may be releasably secured to both an upper mold component of a second modular half shell and a lower mold component of a second modular half shell. One or both of the receiver mold components of a first and/or second modular half shell, wherein the receiver mold components comprise receiver inner walls that define a receiver cavity having a first particular shape and design, may be interchanged with another receiver mold component having receiver inner walls that define a receiver cavity having a second unique shape and design as long as the structure of the receiver mold components of the first and second modular half shells allows the receiver mold components of the first and second modular half shells to be releasably secured to both a corresponding upper and lower mold component. The shape and design of the receiver inner walls that define a receiver cavity may vary as desired by one of skill in the art to create a plurality of unique, customized glass containers, as long as the structure of the receiver mold component allows the receiver mold component to be releasably secured to both a corresponding upper mold component and a lower mold component.

In another embodiment, a lower mold component of the first modular half shell is releasably secured to a corresponding receiver mold component of the first modular half shell. A lower mold component of the second modular half shell is releasably secured to a corresponding lower mold component of the second modular half shell. In one embodiment, one or both lower mold components of the first and/or second modular half shells, wherein the lower mold components comprise lower inner walls that define a lower cavity having a first particular shape and design, may be interchanged with one or both alternative lower mold components having lower inner walls that define a lower cavity having a second particular shape and design as long as the structure of the lower mold components of the first and/or second modular half shells allows the lower mold components of the first and second modular half shells to be releasably secured to the corresponding receiver mold components of the first and second modular half shell. The shape and design of the lower inner walls that define a lower cavity may vary as desired by one of skill in the art to create a plurality of unique, customized containers, as long as the structure of the upper mold component allows the upper mold component to be releasably secured to the receiver mold component.

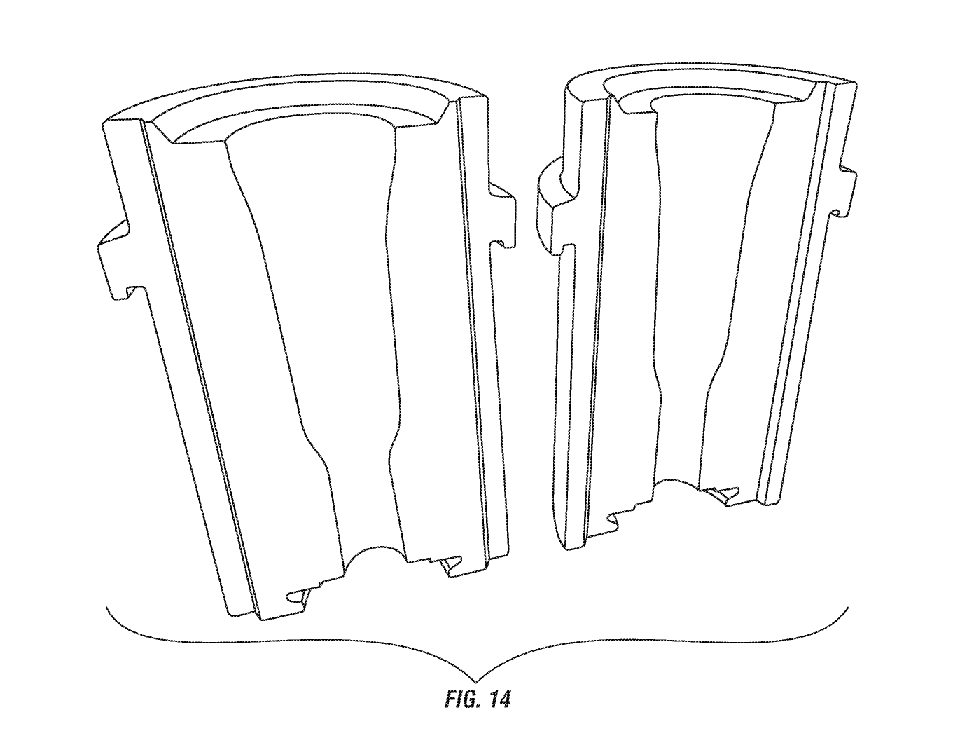

Referring now to FIG. 13, in one example embodiment, modular mold assembly 100 may be used to produce a glass container shape which may be customized to suit the custom needs of a variety of customers. In one example embodiment, modular mold assembly 100 comprising separable and interchangeable upper, receiver, and lower mold components allows various custom styles of a container to be manufactured at a minimized cost. Each of the exemplary customized bottles, shown in FIG. 13, would typically utilize the same blank mold but would require a different blow mold, thus requiring an entire mold set to be manufactured for each customized bottle. Modular mold assembly 100 allows the formation of custom glass containers as exemplified in FIG. 13 without the formation of a complete mold set for each custom designed glass container. In one embodiment, glass container A may be formed with a modular mold assembly comprising upper, receiver and lower components releasably secured together wherein the inner walls that define the cavities of each of the upper, receiver and lower mold components has a basic shape and design used to form glass container A. Glass container B may be formed with a modular mold assembly wherein the receiver and lower mold components (as well as the neck ring and bottom plate) are the same as those used to form glass container A but wherein one of the upper mold components used to produce glass container A may be interchanged with an upper mold component having upper inner walls that define a upper cavity having a unique shape and design used to form glass container B. Glass container C was formed with a modular mold assembly of glass container A but wherein one of the receiver mold components used to produce glass container A was interchanged with a receiver mold component having receiver inner walls that define a receiver cavity having a unique shape and design used to form glass container C. Glass container D may be formed with a modular mold assembly of glass container A but wherein one of the lower mold components used to produce glass container A was interchanged with a lower mold component having lower inner walls that define a lower cavity having a unique shape and design used to form glass container D. Glass container E may be formed with a modular mold assembly having one of the upper, receiver and lower mold components interchanged with the upper, receiver, and lower mold components of glass container A, wherein the upper, receiver and lower mold components each has inner walls that define the cavity of each of the upper, receiver and lower mold components having a unique shape and design used to form glass container E. Each glass container shown in FIG. 13 was formed by using the same blank mold (shown in FIG. 14) which forms the parison as well as the same neck ring and bottle plate therefore considerably reducing the cost involved for customized design glass bottles or other containers.

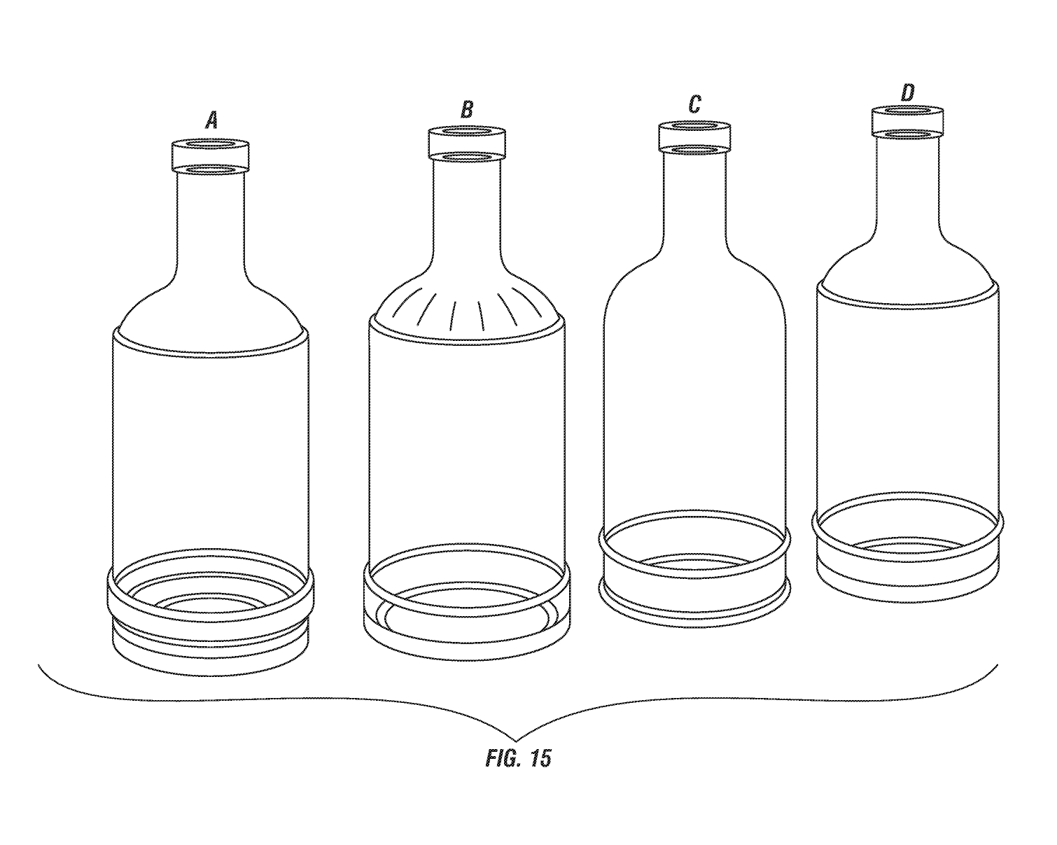

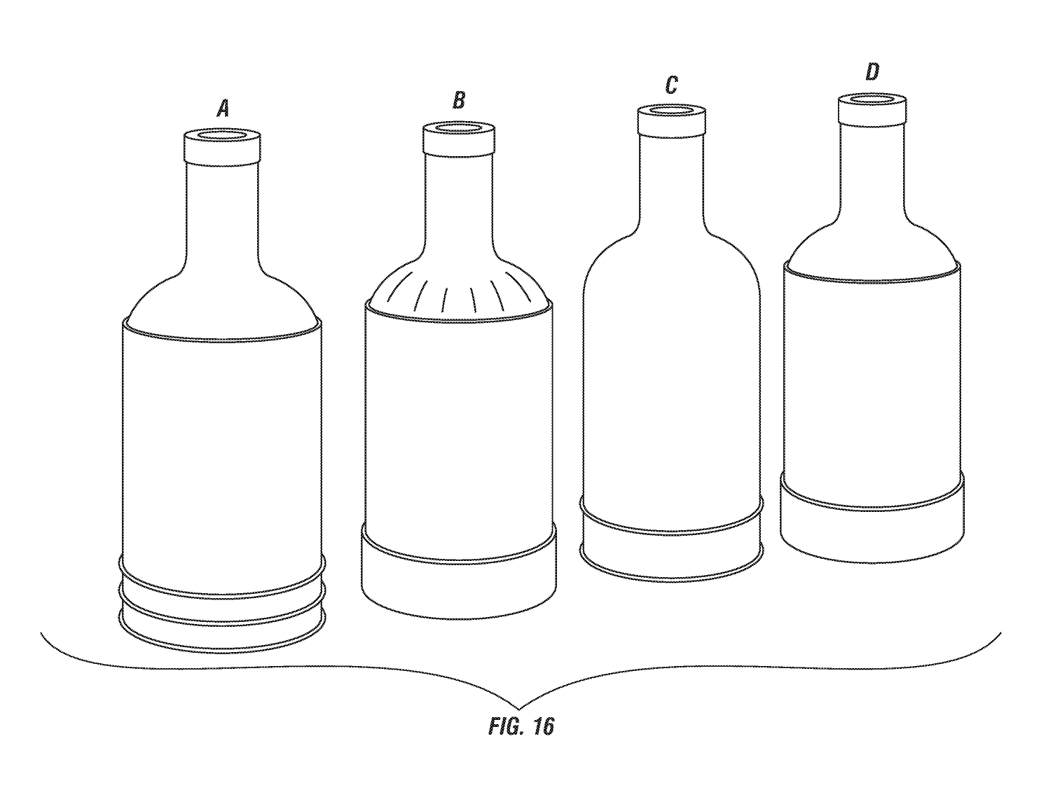

Referring now to FIGS. 15 and 16, in a second example embodiment, the modular mold assembly 100 may be used to produce a bottle shape which may be customized to suit the custom needs of a variety of customers. In one example embodiment, the modular mold assembly 100 comprising separable and interchangeable upper, receiver, and lower mold components allows several custom styles of a container to be manufactured at a minimized cost. Each of the customized bottles, shown in FIGS. 15 and 16, would typically require a different blow mold, but the modular mold assembly allows the formation of custom glass containers as exemplified herein. In one embodiment, glass container A may be formed with a modular mold assembly comprising upper, receiver and lower components releasably secured together wherein the inner walls that define the cavities of each of the upper, receiver and lower mold components have a basic shape and design used to form glass container A. Glass container B may be formed with a modular mold assembly wherein the receiver mold components (as well as the neck ring and bottom plate) are the same as those used to form glass container A but wherein the upper and lower mold components used to produce glass container A may be interchanged with upper and lower mold components having upper inner walls and lower inner walls that define a upper cavity and lower cavity, respectively, each having a unique shape and design used to form glass container B. Glass container C may be formed with a modular mold assembly wherein the receiver mold components (as well as the neck ring and bottom plate) are the same as those used to form glass container A and glass container B but wherein the upper and lower mold components used to produce glass containers A and B may be interchanged with upper and lower mold components having upper inner walls and lower inner walls that define a upper cavity and lower cavity, respectively, each having a unique shape and design used to form glass container C. Glass container D may be formed with a modular mold assembly of glass container A but wherein the lower mold components used to produce glass container A are interchanged with lower mold components having lower inner walls that define a lower cavity having a unique shape and design used to form glass container D. Each bottle shown in FIGS. 15 and 16 was formed by using the same blank mold, shown in FIG. 14, which forms the parison as well as the same neck ring and bottle plate therefore considerably reducing the cost involved for customized design glass bottles or other containers.

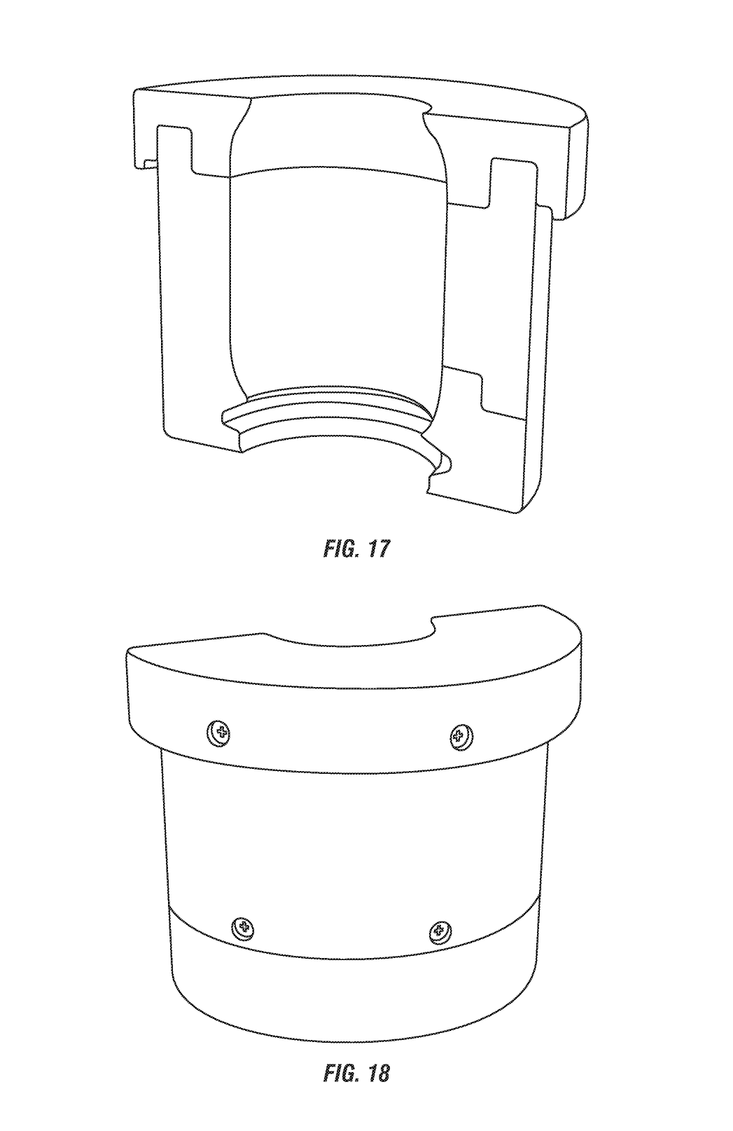

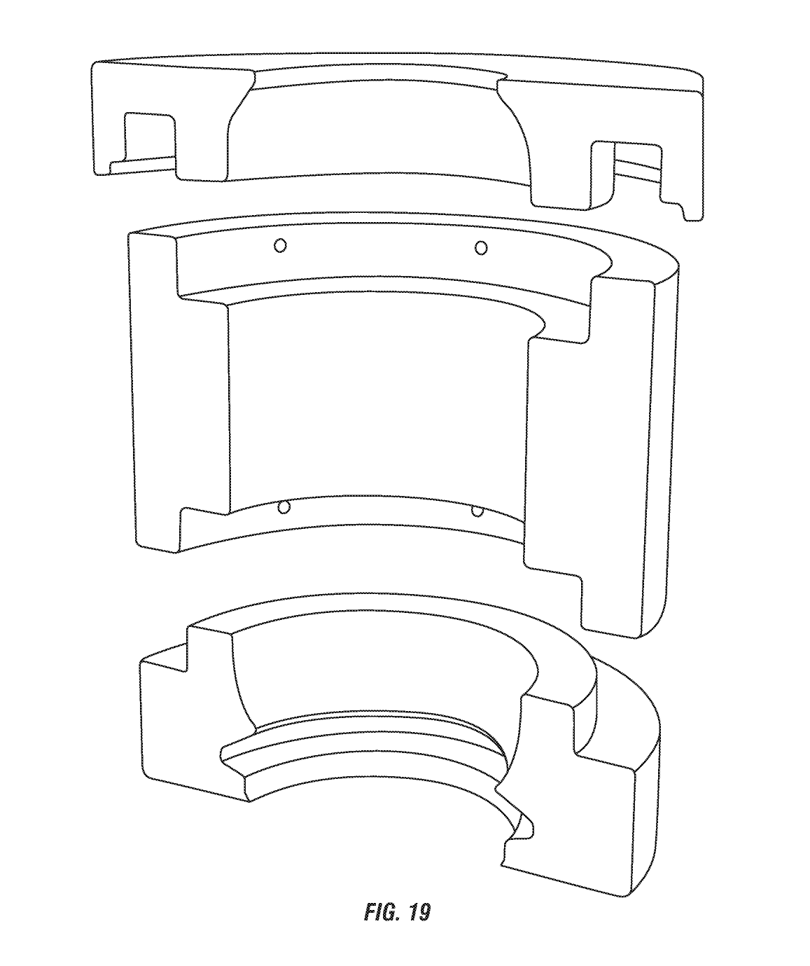

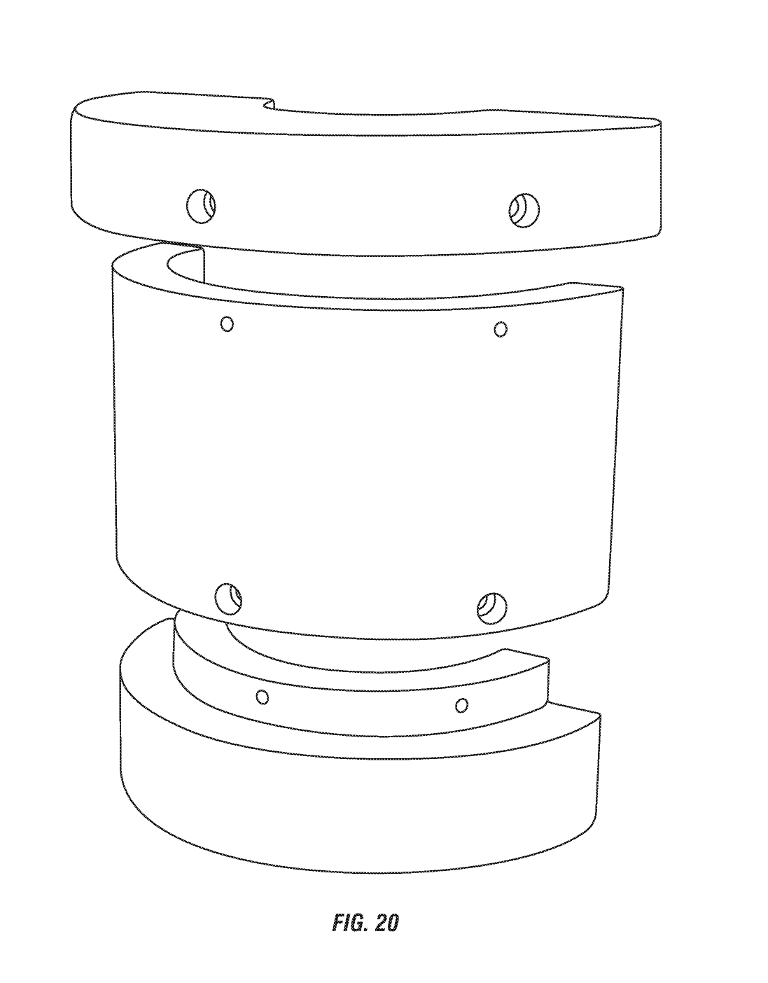

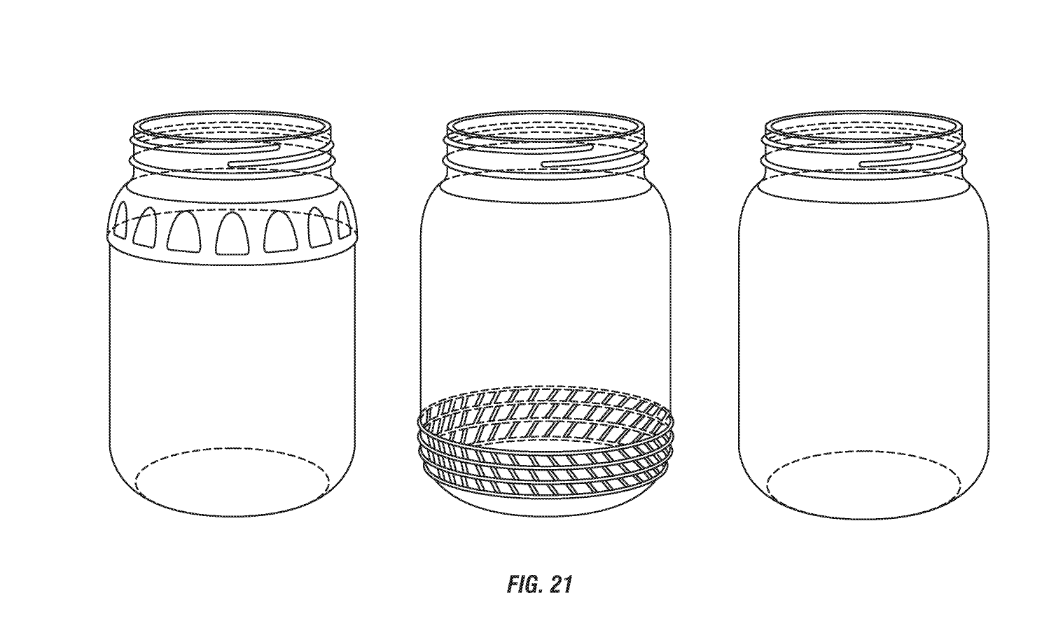

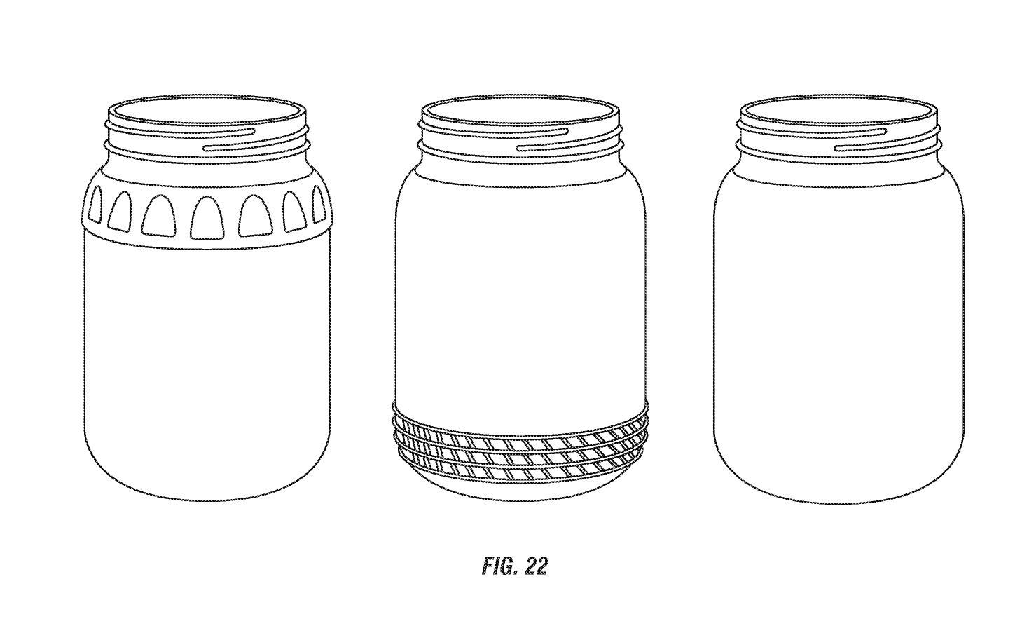

Referring now to FIGS. 17 to 20, another example embodiment of a first modular mold half shell is disclosed. Such modular mold half shell may be used in conjunction with a second modular mold half shell, a neck ring and a bottom plate to form a modular mold assembly which is used to form a glass container such as a jar. Each modular mold half shell comprises a plurality of separable and interchangeable components, including an upper and lower mold components as well as a receiver mold component, which allow for the production of a plurality of glass containers each having a unique, customized design. Modular mold assembly 100 may be used to produce a glass container shapes, such as the glass jars shown in FIGS. 21 and 22, which may be customized to suit the custom needs of a variety of customers. In one example embodiment, modular mold assembly 100 comprising separable and interchangeable upper, receiver, and lower mold components allows various custom styles of a glass container to be manufactured at a minimized cost. Each of the exemplary customized glass jars, shown in FIG. 21, would typically utilize the same blank mold but would require a different blow mold, thus requiring an entire mold set to be manufactured for each customized bottle. Modular mold assembly 100 allows the formation of custom glass containers as exemplified in FIG. 21 without the formation of a complete mold set for each custom designed glass container.

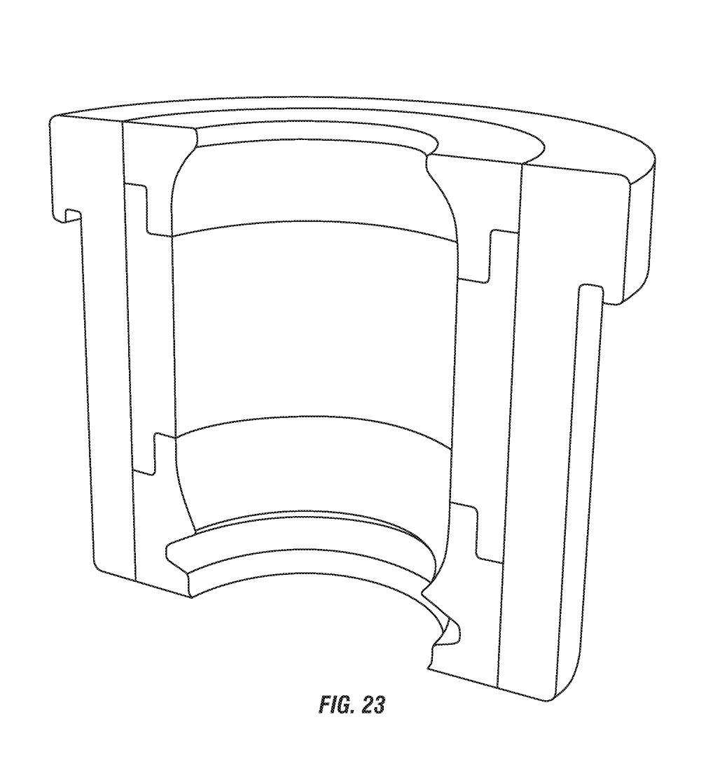

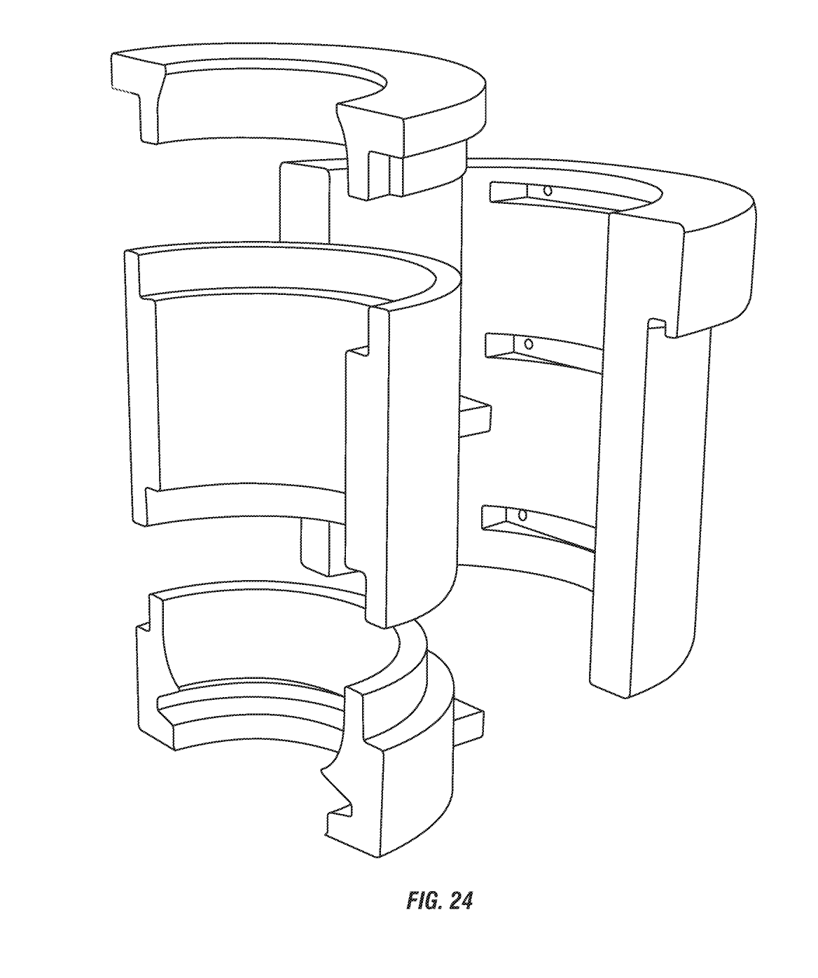

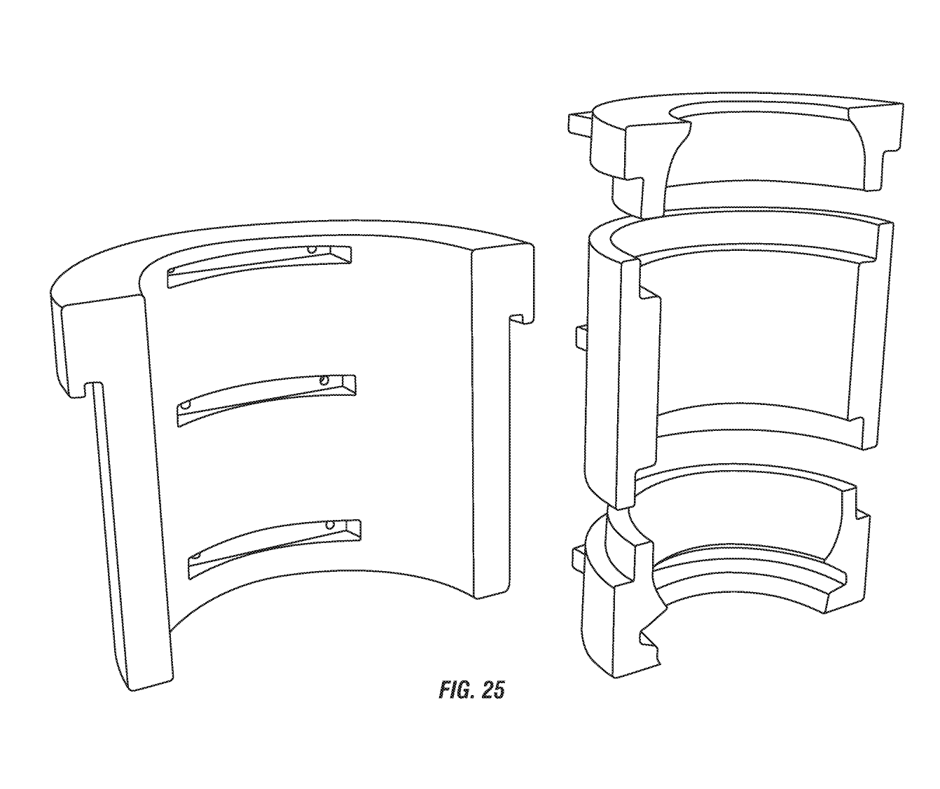

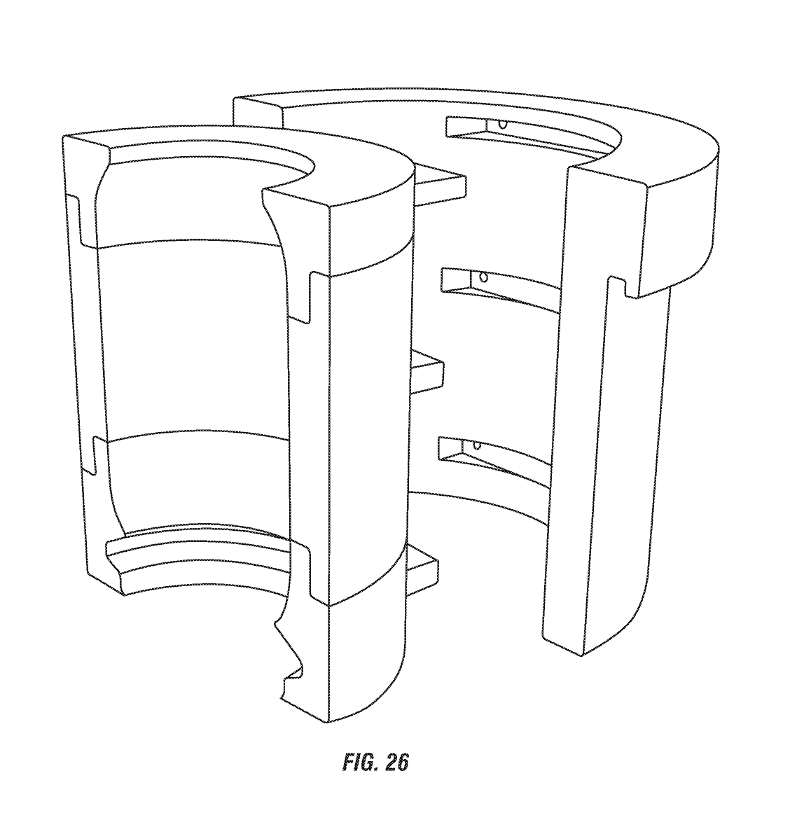

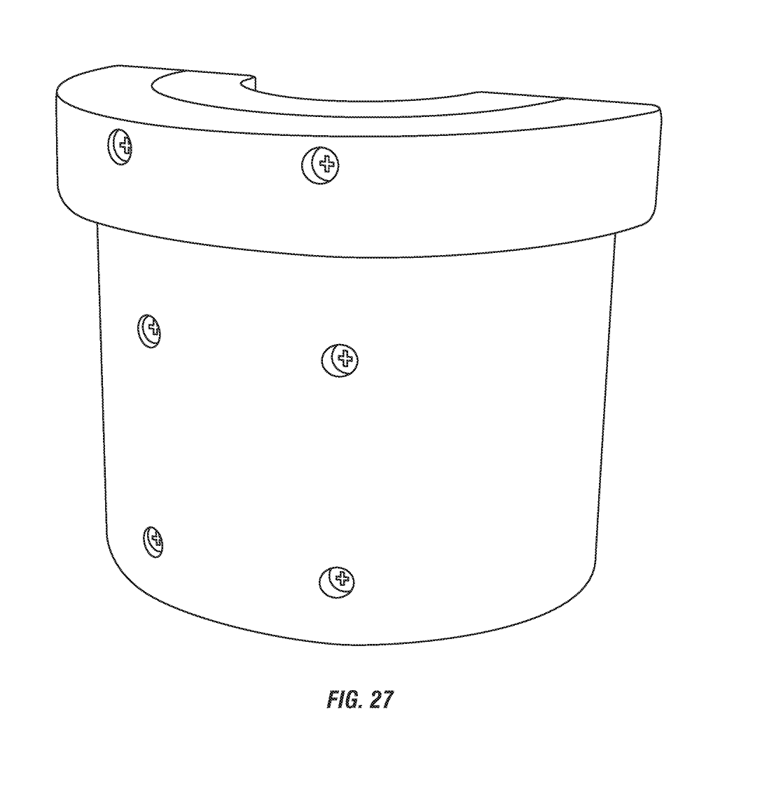

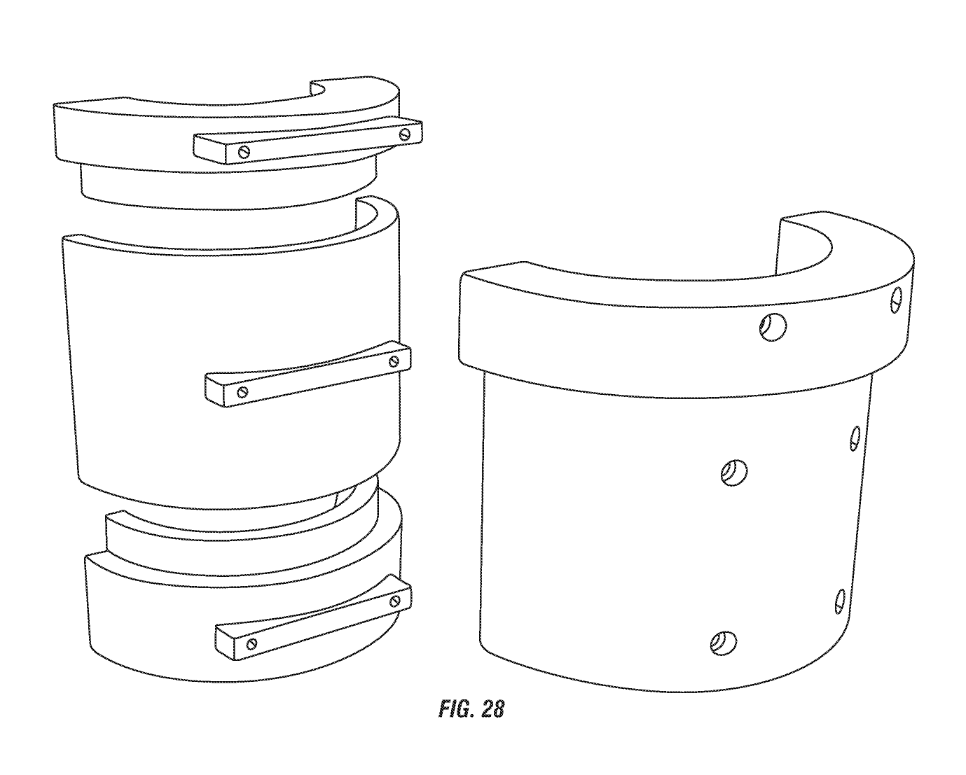

Referring now to FIGS. 23 to 28, modular mold assembly 100 may comprise a module holder configured to receive the upper, receiver, and lower mold components. In the example embodiment, each of the upper, receiver and lower mold components comprise projection protruding from the rear side of the component, best seen in FIG. 28. The module holder comprises a plurality of apertures configured to receive each projection located on the lower, upper and receiver mold components. The mold component projections may be attached to the module holder with screws, but other forms of attachment may be used as desired by one of skill in the art.

A new method of manufacturing customized glass containers which utilizes such modular mold assembly is also disclosed. A method of manufacturing customized glass containers, the method comprising the following step of: (a) using a modular mold assembly having a unique shape and/or design in a glass formation machine, the modular mold assembly comprising: (1) two modular mold half shells, a first modular mold half shell and a second modular half shell, wherein each modular half shell comprises separable and interchangeable components wherein the components are releasably secured together; (2) a neck ring and (3) a bottom plate.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the disclosed invention and equivalents thereof.

We claim:

1. A modular mold assembly used to make a glass container having a unique shape and/or design, the modular mold assembly comprising:
two modular mold half shells, a first modular mold half shell and a second modular half shell, wherein each modular half shell comprises separable and interchangeable components wherein the components are releasably secured together;
a neck ring and
a bottom plate.

2. The modular mold assembly of claim 1, wherein each modular half shell comprises separable and interchangeable components comprising an upper mold component releasably secured to a receiver mold component which is releasably secured to a lower mold component.

3. The modular mold assembly of claim 2, wherein each upper mold component comprises upper inner walls that are configured to define an upper cavity when the upper mold components of each half shell are pressed together during glass container formation, wherein the upper cavity has a shape and design which conforms to the shape and design of the upper portion of the glass container to be formed, wherein each receiver mold component comprises receiver inner walls that are configured to define a middle cavity when the receiver mold components of each half shell are pressed together during glass container formation, wherein the receiver cavity has a shape and design which conforms to the shape and design of the receiver portion of the glass container to be formed; and wherein each lower mold component comprises lower inner walls that are configured to define a lower cavity when the lower mold components of each half shell are pressed together during glass container formation, wherein the lower cavity has a shape and design which conforms to the shape and design of the lower portion of the glass container to be formed.

4. A method of manufacturing customized glass containers, the method comprising the following step of:
(a) using a modular mold assembly having a unique shape and/or design in a glass formation machine, the modular mold assembly comprising: (1) two modular mold half shells, a first modular mold half shell and a second modular half shell, wherein each modular half shell comprises separable and interchangeable components wherein the components are releasably secured together; (2) a neck ring and (3) a bottom plate.
